(19) United States
(12) Patent Application Publication
(10) Pub. No.: US 2026/0034565 A1
(43) Pub. Date: Feb. 5, 2026

(54) POUCH SORTER ARRANGEMENT

(71) Applicant: Beumer Group GmbH & Co. KG, Beckum (DE)

(72) Inventor: Bjarne Denhardt Johansen, Odder (DK)

(73) Assignee: Beumer Group GmbH & Co. KG, Beckum (DE)

(21) Appl. No.: 19/283,340

(22) Filed: Jul. 29, 2025

(30) Foreign Application Priority Data
Jul. 30, 2024 (EP) 24191678.2

(51) Int. Cl. B07C 3/00; B07C 3/08

(52) U.S. Cl. CPC B07C 3/008; B07C 3/08

(57) ABSTRACT

A sorting arrangement for sorting objects, such as parcels of small and medium size, for loading onto a transport vehicle for delivery from a storage facility, such as a distribution centre, said arrangement comprising a pouch sorter having a plurality of hanging pouches for receiving and storing objects therein, including at least one delivery pouch buffer receiving said individually transferred pouch or group of pouches; wherein the pouches are transferred to the delivery pouch buffer in a predetermined sequence for providing a sequential delivery pouch buffer at the delivery vehicle loading position.

### CROSS-REFERENCE TO RELATED APPLICATIONS

This application claims priority to EP24191678.2 filed Jul. 30, 2024, which is hereby incorporated by reference.

### FIELD OF THE INVENTION

The present invention relates to a sorting arrangement for sorting objects, such as mail items and parcels of small and medium size, for loading onto a transport vehicle for delivery from a storage facility, such as a distribution centre.

### BACKGROUND OF THE INVENTION

EP 4 115 994 B1 discloses a sorter arrangement comprising a pouch sorter having a plurality of hanging pouches for the objects to be sorted. The pouch sorter is provided with a pouch unloading means from which the pouches are unloaded into at least a second terminal different from the at least one first terminal. The pouch sorter system can be sorting the pouches ejected from a pouch buffer so that they have a desired sequence.

In EP 3 653 539 A1 there is known a pouch sorter where individual pouches can be manually or automatically discharged from the pouch line and onto an underlying line conveyor.

EP 4 168 330 A1 describes a pouch for a pouch sorter, the pouch having a divisible pouch base with two pouch base halves, which are connected to one another via a locking mechanism and can be released from one another in a release position of the locking mechanism, the locking mechanism being driven by a drive between a closed position and the Release position.

Such pouch are desirable in particular for pouch sorters in which automatic pouch unloading is provided, which does not require any operating personnel to unload the pouch.

Pouch sorter system may be used in storage and distribution centres, e.g. in relation to postal/parcel distribution of mail items and small and medium sized parcels or e-commerce centres. Common to such distribution centres is that the objects are being sorted so that they can be loaded onto a delivery vehicle, such as a delivery van, for delivery at the recipient of the mail or parcel. The final loading of the delivery van is today performed manually by the driver of the van, which is time consuming.

In the present disclosure, a delivery van, a transport truck or the like is commonly referred to as a transport delivery vehicle.

It is therefore an object by the present invention to facilitate a faster final handling process for loading of the transport delivery vehicle or vehicles. Often a plurality of delivery vehicles are positioned alongside each other at an outlet section of the distribution centre. This increases the time consumed for preparing the final delivery and an object is therefore also to reduce the necessary time for loading a plurality of transport vehicles in parallel.

### SUMMARY OF THE INVENTION

This object is achieved in a first aspect of the invention by providing a sorting arrangement for sorting objects, such as parcels of small and medium size, for loading onto a transport vehicle for delivery from a storage facility, such as a distribution centre, said arrangement comprising a pouch sorter having a plurality of hanging pouches for receiving and storing objects therein, including at least one delivery pouch buffer receiving said individually transferred pouch or group of pouches; wherein the pouches are transferred to the delivery pouch buffer in a predetermined sequence for providing a sequential delivery pouch buffer at the delivery vehicle loading position.

In a distribution centre, where often several delivery vans are being prepared for delivery of parcels to end users/recipients. This preparation includes loading the parcels onto the delivery vehicle and preparing a route for the delivery vehicle. According to the invention, there is provided a delivery pouch buffer, preferably at the at least one delivery vehicle loading position, in the distribution centre, which is found advantageous since the parcels while in the hanging pouches can be sorted into delivery buffers for each of the delivery vehicles and also being sorted such that the parcels are presented in a delivery sequence to the operator who is loading the vehicle by sequencing the pouches with parcels when the pouches with the parcels are transferred to the delivery pouch buffer at each of the delivery vehicle loading positions. Hereby, a significant amount of time is saved since the operator does not manually have to determine how to load the parcels onto the van. The advantage is also that the driver of the delivery vehicle save time in finding the individual parcels at the delivery points on the route, since the parcels are loaded onto the vehicle in a sequence corresponding to the route.

In an embodiment of the pouch sorter, the hanging pouches are preferably provided with discharging means for automatically emptying the pouches. The pouches can also be unloaded manually. In case of an automatic pouch opening, the parcels in the pouch can then fall onto a conveyor means, that transfer the parcels to the operator/driver inside the delivery vehicle, from which the operator can load the parcels into the vehicle. Advantageously, the hanging pouches in the sequential delivery buffer are sequentially opened and thereby emptied onto said conveyor means.

Preferably, the sequential delivery buffer at the delivery vehicle loading position is provided above conveyor means for the transfer of the parcels to storage inside the transport delivery vehicle either automatically or manually assisted by the operator. The conveyor means may be a chute, a roller conveyor, a conveyor belt or a boom conveyor depending on the actual design of the sorting arrangement and design of the distribution centre. This allows for automatic parcel release/drop from the pouches to the conveyor and transferred to the vehicle in its route sequence. The route can be via the parcels in the system and/or the parcels still to be expected. In addition, no 1:1 sequencing based on the route needs to take place. In some cases an approximate sequencing will also be sufficient.

In some preferred embodiments, the pouch sorter further comprises at least one pouch storage from which the pouches can be transferred individually, and wherein said pouch storage preferably comprises multiple buffer circuits. Hereby, the delivery pouch buffer for sequence sorting the objects for loading onto a transport delivery vehicle may advantageously be integrated with the storage and sorting facilities in the distribution centre, storage facility or the like.

Preferably, a control system is provided for monitoring the sorting, sequencing and loading of the transport delivery vehicle, said control system comprising a scanning system to identify the parcels and then assign them to a pouch. The parcels may be automatically placed in the pouches or the positioning is carried out manually based on the assignment of the control system. The hanging pouches may furthermore be provided with identification means, such as RFID tags or the like, so that the control system can identify the individual pouches in the pouch sorter. Furthermore, the scanning system of the control system may preferably comprise sensors, such as cameras or the like, to monitor the emptying of the pouches onto the conveyor means.

Advantageously, the control system may be adapted to empty the objects of the sequenced pouches in the sequential delivery buffer onto the conveyor means at a regular interval, or the control system is adapted to control the emptying by manual ordering means for ordering the next pouch to be emptied. The control system may automatically generate a signal activating the automatic discharge means of each of the pouches in the delivery pouch buffer. Alternatively, this signal may be generated by an operator supervising the loading operation of the delivery vehicle. Such signal can be generated by the press of a button on the conveyor means, e.g. the boom conveyor, or the signal can be generated on a mobile device to order the next parcel/object to be discharged from the next pouch in the sequenced delivery pouch buffer. Hereby, it may be possible for the operator/driver to manually confirm when the next parcel is to be unloaded onto the conveyor means.

The predetermined sequence of the pouches in the at least one sequential delivery pouch buffer is preferably managed by the control system based on the route of the transport delivery vehicle to be loaded. Hereby, the parcels may be loaded onto the delivery vehicle in an order sorted after the delivery points of the parcels/objects.

Accordingly, the control system may be provided with item information of all sorted objects that are received on the pouch sorter, and the control system may be adapted to calculate the route of the one or more transport delivery vehicles based on said items information, and furthermore the control system may be adapted to produce the sequence of pouches in the delivery pouch buffer based on said item information. Hereby, the automatic sortation in a distribution centre or the like can advantageously be extended to include the delivery transport vehicle loading.

Not only item information of all sorted objects from pouch sorter, but also the item information on the objects/parcels that are still expected in delivery vehicles and have to be sorted. The operator will know which parcels are in which delivery vehicle, not necessarily where in the delivery vehicle, and for example, that the parcels that are still awaiting delivery are in a delivery vehicle and will be unloaded in later.

Advantageously, a plurality of pouch delivery buffers are provided at each of a plurality of delivery vehicle loading positions. Hereby, the pouch sorter includes sortation means for supply the delivery pouch buffers of all the delivery vehicle loading positions. Accordingly, said plurality of pouch delivery buffers may be sequenced from a distribution pouch sorter receiving pouches from the at least one pouch storage, said distribution pouch sorter being a line sorter or a loop sorter.

In an embodiment of the invention, the delivery pouch buffer can hold at least 30% of the items up to 100% of the objects for the transport delivery vehicle being received at the delivery vehicle loading position. In storage facilities used for e-commerce, usually 70-80% of the parcels are small or medium sized parcels that can fit into the hanging pouches and therefore be handled on the pouch sorter. In case of larger parcels, e.g. larger than 5 kg, the sorting arrangement according to the invention is preferably provided with means for handling such parcels of larger or odd size. Accordingly, such second type of objects are provided in a roll container at one or more delivery vehicle loading positions using a second sorter system, such as a line sorter or the like.

In a second aspect of the invention, there is provided a method of sorting objects, such as parcels of small and medium size, for loading onto a transport vehicle for delivery from a storage facility, such as a distribution centre, said method comprising the steps of:
sorting and storing objects in a plurality of hanging pouches in a pouch storage of a pouch sorter, and
sequencing said pouches in a predetermined sequence; and
buffering the sequenced pouches in a delivery pouch buffer at a transport delivery vehicle loading position in the predetermined sequence for providing a sequential delivery pouch buffer, and
unloading the pouches one by one said sequence and loading said pouches in the transport delivery vehicle.

The integrated control system may include control and sequence loading of small and medium parcels from the pouch system and larger parcels from another sorting system, loop or line sorter system.

Accordingly, there is also provided a method for sorting objects to one or more delivery pouch buffers at delivery vehicle loading positions in the distribution centre. Hereby, time savings are achieved in the preparation of the final delivery by sequencing the pouches with parcels when the pouches with the parcels are transferred to the delivery pouch buffer at each of the delivery vehicle loading positions. The method may preferably be performed by a sorting arrangement as described above.

### BRIEF DESCRIPTION

In the following, the invention is described in more detail with reference to the embodiments shown in the accompanying drawings, in which:

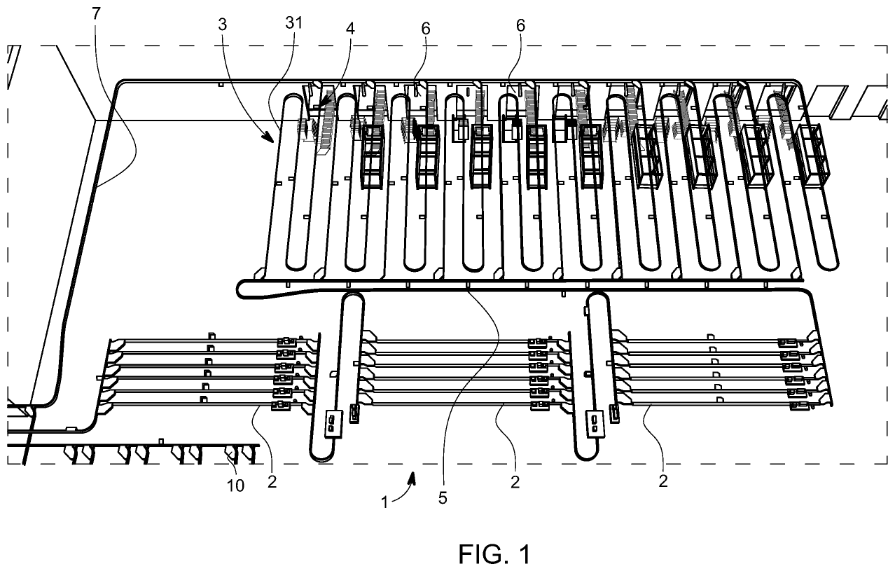

FIG. 1 is a schematic perspective view of a first embodiment of the invention;

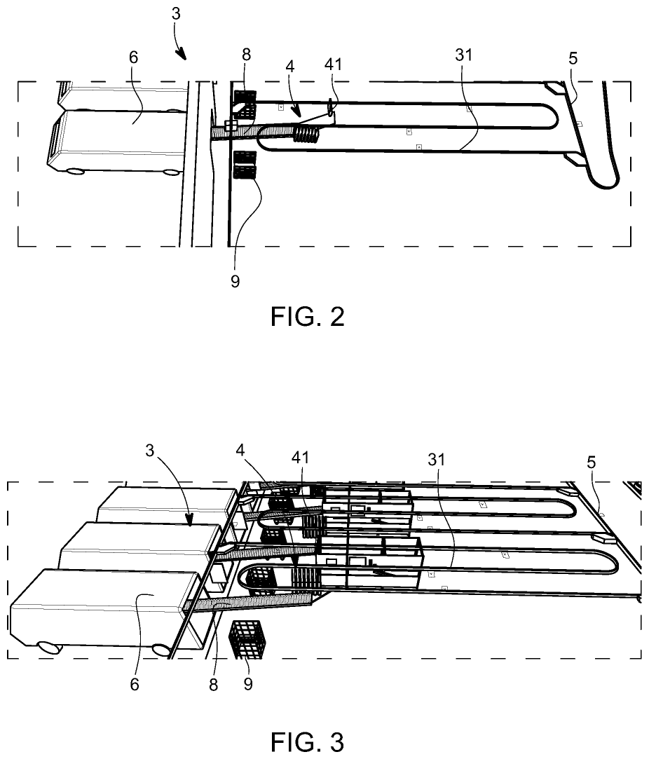

FIG. 2 is a detailed schematic perspective view of a pouch buffer line according to an embodiment of the invention; and

FIG. 3 is another detailed schematic perspective view of a pouch buffer line according to an embodiment of the invention.

### DETAILED DESCRIPTION

In FIG. 1 there is schematically illustrated a distribution centre wherein a pouch sorter 1 is arranged. Small to medium-sized parcels are loaded into the pouch sorter manually or automatically. The objects, i.e. parcels, are placed into hanging pouches 10, which are individually identifiable by sensors or the like of the control system (not shown) of the pouch sorter 1. The hanging pouches 10 are suspended from transport lines and contains one or more pouch storages 2 from which the hanging pouches 10 can be stored and transferred to one of the several transport delivery vehicle loading positions 3 arranged in the distribution centre for loading the parcels in the pouches 10 onto the transport delivery vehicles 6 parked at the gates or the transport delivery vehicle loading positions 3. The transport pouch lines may preferably include a pouch supplying line 5 for transferring the pouches onto pouch buffer lines 31 at each of the vehicle delivery positions 3 and a return line 7 for returning the pouches after they have been emptied or if a pouch is rejected at the delivery and have to be returned to the storage.

In FIGS. 2 and 3, the delivery pouch buffer 4 at one of the transport delivery vehicle loading positions 3 is shown. At each of the transport delivery vehicle loading positions 3 there is provided a delivery pouch buffer 4 where the pouches (containing the parcels) for final delivery by the specific delivery vehicle 6 parked at the associated gate. On the sorter the pouches 10 can be stored at the storage 2 for a certain period of time awaiting the sortation for a particular delivery. In the control system the route of the delivery vehicle is entered or calculated so that the sortation of the pouches with the parcels for this delivery route can start and said sortation involves sequencing the pouches for the route of the delivery vehicle 6. Once sequenced, these pouches are buffered in the delivery buffer line 4 in front of the delivery vehicles 6 in the correct sequence. This sortation can be performed either when the delivery vehicle 6 is at the gate, i.e. in the designated transport delivery vehicle loading position 3 or the sortation may be prepared in the delivery buffer line 4 awaiting a delivery vehicle 6 to arrive. In any case, the pouches are eventually unloaded one by one in route sequence and then loaded onto the delivery vehicle 6.

The pouches 10 can be unloaded manually, but they can also be unloaded automatically by the automatic pouch. In the embodiment shown in the figures, an automatic Pouch opening is performed at an automatic pouch discharge station 41 in the delivery pouch buffer 4. When the parcels are discharged from the pouches, said parcels then fall onto conveyor means 8, such as a chute, a roller conveyor, a conveyor belt or the like.

From the conveyor 8 the parcels are transferred to the operator/driver inside the storage room of the delivery vehicle 6, where the operator can load the parcels into the delivery vehicle 6. The conveyor means could also be a boom conveyor, which can be extended and thereby reach into the storage room of the delivery vehicle 6 in order to assist the operator in the task of loading the vehicle. The conveyor means 8 and/or the automatic pouch discharge 41 may be controlled by the control system. In one embodiment, it may be possible for the operator to manually confirm when the next parcel is to be discharged and unloaded onto the conveyor means. Alternatively, the control system may comprise sensors or a camera can be used to monitor and control the loading process and/or a timer could release a parcel onto the conveyor 8 at regular intervals, such as every 5-60 seconds.

The predetermined sequence of the pouches in each of the sequential delivery pouch buffers 4 are managed by the control system based on the routes of the transport delivery vehicles 6 to be loaded. The control system My be provided with item information of all sorted objects that are received on the pouch sorter. Based on said items information, the control system may be adapted to calculate the route of the one or more transport delivery vehicles. This route may alternatively be manually uploaded to the control system of the pouch sorter. The control system may further be adapted to produce the sequence of pouches in the delivery pouch buffers based on said item information.

Usually, a delivery vehicle is designated to contain 100-200 parcels. This normally may take the operator/driver up to one hour to load. By the present invention, this loading time can be significantly reduced by the automatic sequencing of the parcels.

The automatic sortation using a pouch sorter is practical for about 70-80% of the parcels usually handled in a distribution centre in the courier express parcel (CEP) industry. These small to medium-sized parcels will fit into the pouches in the pouch sorter. By small and medium parcels suitable for automatic sortation there are certain limitations as to the size of the parcel, its weight and also in certain cases its density.

For handling larger parcels/objects, there is provided a second embodiment of the invention, wherein the pouch sorter is supplemented with a second sorter system for handling larger objects, such as parcels of larger or odd size. On this second sorter system, such as a line sorter or the like, the large or odd-size parcels are sorted into roll containers 9 that are transferred to the delivery vehicle loading positions 3 using this second sorter system. In the figures, roll containers 9 are illustrated. However, by the invention it is realised that any other kind of object handling equipment may be used, such as a mobile robot, a roller cage or an additional conveyor belt, etc.

The integrated control system may include control and sequence loading of small and medium parcels from the pouch system and larger parcels from another sorting system, loop or line sorter system.

In general, when directional terms like “upper” and “lower” or similar directional references are used in the present disclosure, these terms are meant to be understood as relative terms e.g. where the term “upper” refers to a direction essentially opposite to the “lower”, but it is realised that the planar assembly when in use can be positioned with any orientation.

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

Above, the invention is described with reference to some currently preferred embodiments. However, by the invention it is realised that other embodiments and variants may be provided without departing from the scope of the invention as defined in the accompanying claims.

### LIST OF REFERENCE SIGNS

1 Pouch sorter
2 Pouch storage
3 transport delivery vehicle loading position
4 delivery pouch buffer
5 pouch supplying line
6 transport delivery vehicle
7 Return pouch line
8 conveyor means
9 roll container
10 hanging pouches
31 pouch buffer line
41 automatic pouch discharge station

1. A sorting arrangement for sorting objects, such as parcels of small and medium size, for loading onto a transport vehicle for delivery from a storage facility, such as a distribution centre, said arrangement comprising
a pouch sorter having a plurality of hanging pouches for receiving and storing objects therein, including
at least one delivery pouch buffer receiving said individually transferred pouch or group of pouches;
wherein the pouches are transferred to the delivery pouch buffer in a predetermined sequence for providing a sequential delivery pouch buffer at the delivery vehicle loading position.

2. A sorting arrangement according to claim 1, wherein the hanging pouches are provided with discharging means for automatically emptying the pouches.

3. A sorting arrangement according to claim 2, wherein the hanging pouches in the sequential delivery buffer are sequentially opened and thereby emptied onto conveyor means.

4. A sorting arrangement according to claim 1, wherein one delivery pouch buffer is at a transport delivery vehicle loading position.

5. A sorting arrangement according to claim 1, wherein the sequential delivery buffer at the delivery vehicle loading position is provided above conveyor means for the transfer of the parcels to storage inside the transport delivery vehicle.

6. A sorting arrangement according to claim 1, wherein the conveyor means is a chute, a roller conveyor, a conveyor belt or a boom conveyor.

7. A sorting arrangement according to claim 1, wherein the pouch sorter further comprises at least one pouch storage from which the pouches can be transferred individually, and wherein said pouch storage preferably comprises multiple buffer circuits.

8. A sorting arrangement according to claim 1, wherein there is provided a control system for monitoring the sorting, sequencing and loading of the transport delivery vehicle, said control system comprising a scanning system to identify the parcels and then assign them to a pouch.

9. A sorting arrangement according to claim 8, wherein said scanning system of the control system comprises sensors, such as cameras or the like, to monitor the emptying of the pouches onto the conveyor means.

10. A sorting arrangement according to claim 8, wherein the control system is adapted to empty the objects of the sequenced pouches in the sequential delivery buffer onto the conveyor means at a regular interval, or the control system is adapted to control the emptying by manual ordering means for ordering the next pouch to be emptied.

11. A sorting arrangement according to claim 8, wherein the predetermined sequence of the pouches in the at least one sequential delivery pouch buffer is managed by the control system based on the route of the transport delivery vehicle to be loaded.

12. A sorting arrangement according to claim 8, wherein the control system is provided with item information of all sorted objects that are received on the pouch sorter, and wherein the control system may be adapted to calculate the route of the one or more transport delivery vehicles based on said items information, and wherein the control system may be adapted to produce the sequence of pouches in the delivery pouch buffer based on said item information.

13. A sorting arrangement according to claim 1, wherein a plurality of pouch delivery buffers are provided at each of a plurality of delivery vehicle loading positions.

14. A sorting arrangement according to claim 13, wherein said plurality of pouch delivery buffers are sequenced from a distribution pouch sorter receiving pouches from the at least one pouch storage, said distribution pouch sorter being a line sorter or a loop sorter.

15. A sorting arrangement according to claim 1, wherein the delivery pouch buffer can hold at least 30% of the items up to 100% of the objects for the transport delivery vehicle being received at the delivery vehicle loading position.

16. A sorting arrangement according to claim 1, wherein a second type of objects, such as parcels of larger or odd size, are provided at one or more delivery vehicle loading positions using a second sorter system, such as a line sorter or the like.

17. A method of sorting objects, such as parcels of small and medium size, for loading onto a transport vehicle for delivery from a storage facility, such as a distribution centre, said method comprising the steps of:
sorting and storing objects in a plurality of hanging pouches in a pouch storage of a pouch sorter, and
sequencing said pouches in a predetermined sequence; and
buffering the sequenced pouches in a delivery pouch buffer, preferably at a transport delivery vehicle loading position, in the predetermined sequence for providing a sequential delivery pouch buffer, and
unloading the pouches one by one said sequence and loading said pouches in the transport delivery vehicle.
